(19) United States
(12) Patent Application Publication
(10) Pub. No.: US 2018/0110374 A1
(43) Pub. Date: Apr. 26, 2018

(54) BLENDING APPLIANCE WITH SUCTION BLADE

(71) Applicant: SUNBEAM PRODUCTS, INC., Boca Raton, FL (US)

(72) Inventor: Jamal F. Hammad, Boynton Beach, FL (US)

(73) Assignee: SUNBEAM PRODUCTS, INC., Boca Raton, FL (US)

(21) Appl. No.: 15/571,199

(22) PCT Filed: May 2, 2016
(86) PCT No.: PCT/US2016/030449

§ 371 Date: Nov. 1, 2017

Related U.S. Application Data
(60) Provisional application No. 62/155,905, filed on May 1, 2015.

(51) Int. Cl. A47J 43/07; A47J 43/046

(52) U.S. Cl. CPC A47J 43/0722; A47J 43/046

(57) ABSTRACT

A blending appliance is provided including a motorized base, a blending container, and an agitator configuration fitted into an opening of the blending container and rotatably coupled to the motorized base when the blending container is mounted on the motorized base. The agitator configuration includes a blade arrangement disposed on a spindle performing blending operations on ingredients at a lower end of the blending container. A blade form is disposed on a shaft connected to the spindle performing additional blending operations on ingredients in an upper portion of the blending container. The blade form includes at least two spiral blades disposed on the shaft, and each of the spiral blades having a first end connected to the shaft at a pre-determined distance from the blade arrangement and a second end connected to opposing ends of a crossbar attached at its midpoint to a distal end of the shaft.

### CROSS-REFERENCE TO RELATED APPLICATION

The present application claims benefit of U.S. Provisional Patent Application No. 62/155,905 filed May 1, 2015, entitled “Suction Blade for Blenders”.

### FIELD OF THE INVENTION

The invention relates to food preparation devices. More particularly, the invention relates to a blending or food processing appliance with an improved agitator configuration having both conventional blending blades and a blending implement to resist cavitation in the upper areas of the blending container.

### BACKGROUND OF THE INVENTION

Blending appliances used to blend beverages from solid and liquid ingredients are known. These blending appliances typically use agitators disposed in proximity to the bottom of the blending jar and formed from blade sets that perform different functions. Known problems include cavitation and solidification of blending ingredients in areas of the blending jar remote from the agitator configuration at the bottom of the blending jar.

### SUMMARY OF THE INVENTION

In an embodiment, there is provided a blending appliance including a motorized base, a blending container, and an agitator configuration fitted into an opening of the blending container and rotatably coupled to the motorized base when the blending container is mounted on the motorized base. The agitator configuration includes a blade arrangement disposed on a spindle performing blending operations on ingredients at a lower end of the blending container. A blade form is disposed on a shaft connected to the spindle performing additional blending operations on ingredients in an upper portion of the blending container. The blade form includes at least two spiral blades disposed on the shaft, and each of the spiral blades having a first end connected to the shaft at a pre-determined distance from the blade arrangement and a second end connected to opposing ends of a crossbar attached at its midpoint to a distal end of the shaft.

In an embodiment, there is provided an agitator configuration including a blade arrangement disposed on a spindle performing blending operations on ingredients at a lower end of a blending container, and a blade form disposed on a shaft connected to the spindle performing additional blending operations on ingredients in an upper portion of the blending container. The blade form includes at least two spiral blades disposed on the shaft, and each of the spiral blades having a first end connected to the shaft at a pre-determined distance from the blade arrangement and a second end connected to opposing ends of a crossbar attached at its midpoint to a distal end of the shaft.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a blending appliance with a blending jar with an improved agitator configuration;

FIG. 2 is a partially exploded perspective view of the blending jar with the improved agitator configuration of FIG. 1;

FIG. 3 is an exploded perspective view of the improved agitator configuration of FIG. 2;

FIG. 4 is a front view of the improved agitator configuration of FIG. 2; and

FIG. 5 is a top view of the improved agitator configuration of FIG. 2.

### DETAILED DESCRIPTION OF THE INVENTION

While the present invention may be susceptible to embodiment in different forms, there are shown in the drawings, and herein will be described in detail, embodiments with the understanding that the present description is to be considered an exemplification of the principles of the invention and is not intended to limit the invention to that as illustrated and described herein. Instead, it is envisioned that those skilled in the art may devise various modifications and equivalents without departing from the spirit and scope of the appended claims.

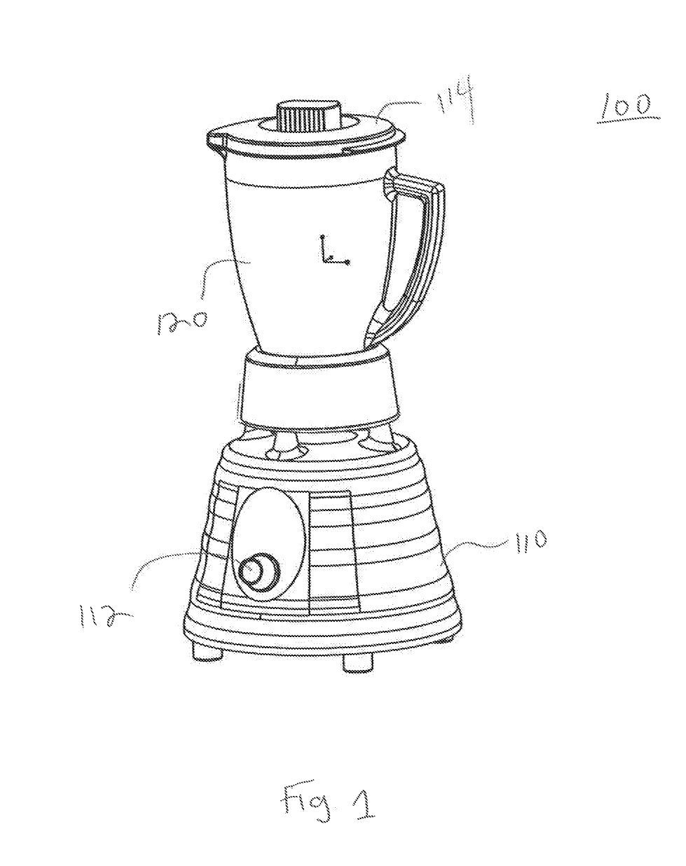

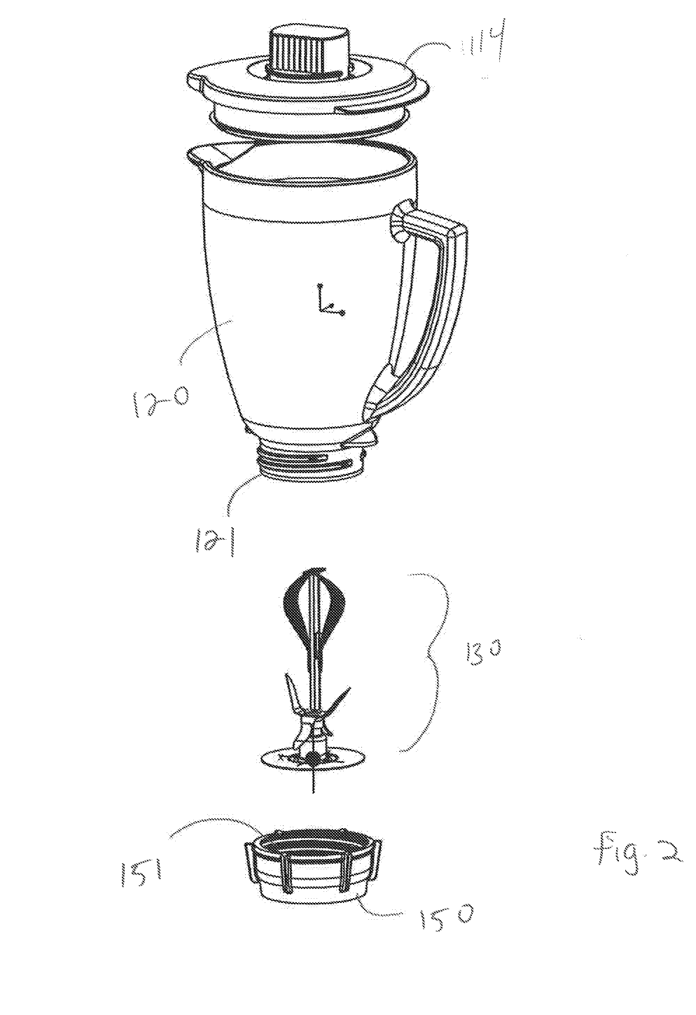

Referring now to FIGS. 1 and 2 of the drawings, in an embodiment there is illustrated a blending or food processing appliance 100. The blending appliance 100 includes a motorized base 110 and a blending jar 120. In use, the blending jar 120 fits into a recess (not shown) formed in the base 110. The blending jar 120 includes a removable lid 114 that fits into an open top of the blending jar 120. The base 110 includes an electrical motor (not shown) for providing rotary power to an agitator configuration 130 disposed within the blending jar 120. Electronic controls 112 in the base 110 control electrical power to the electrical motor (not shown) which in an embodiment may include one or more switches for controlling the electrical motor (not shown) at various speeds including “off”, “low”, “medium” and “high”. In an alternate embodiment, the electronic controls may include a microprocessor (not shown) with memory storing pre-programmed routines for controlling the electrical motor (not shown).

The agitator blade configuration 130 is inserted into an opening (not shown) on the bottom end of the blending jar 120 and secured therein with an agitator nut 150. The agitator nut 150 includes internal threads 151 that engage complementary threads 121 around the opening (not shown) on the bottom end of the blending container 120.

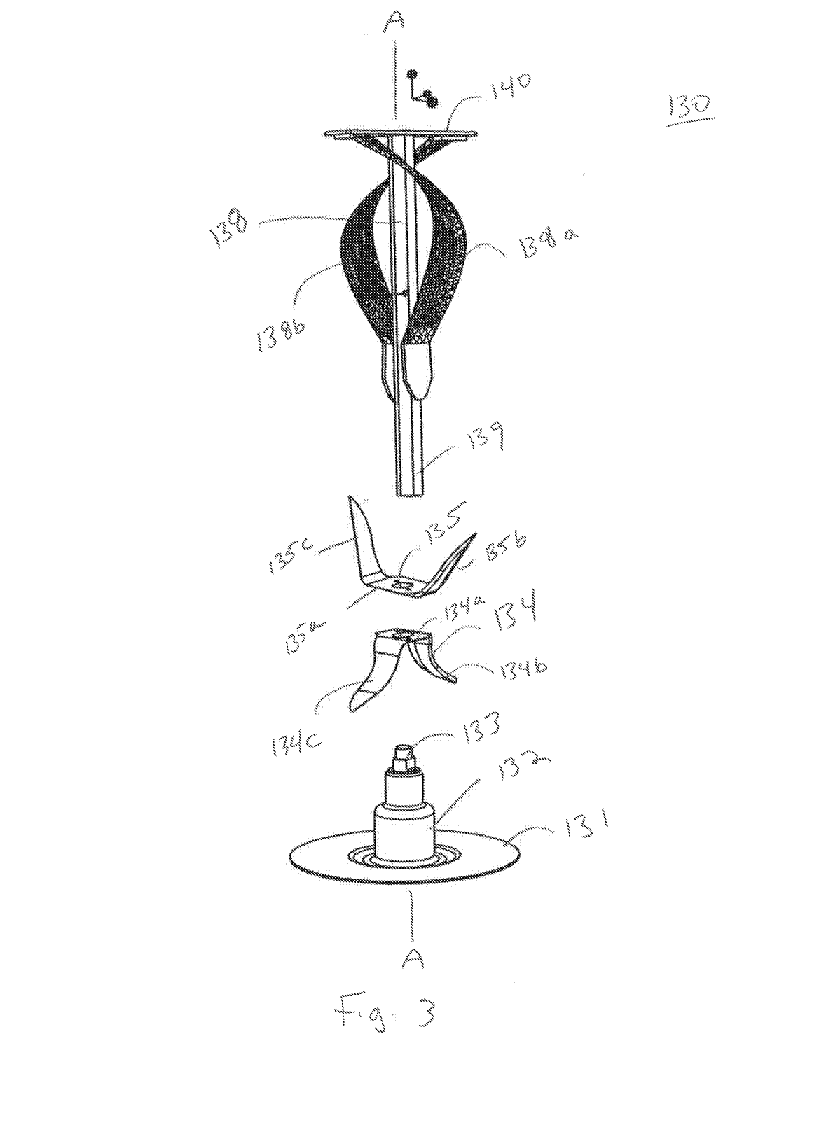

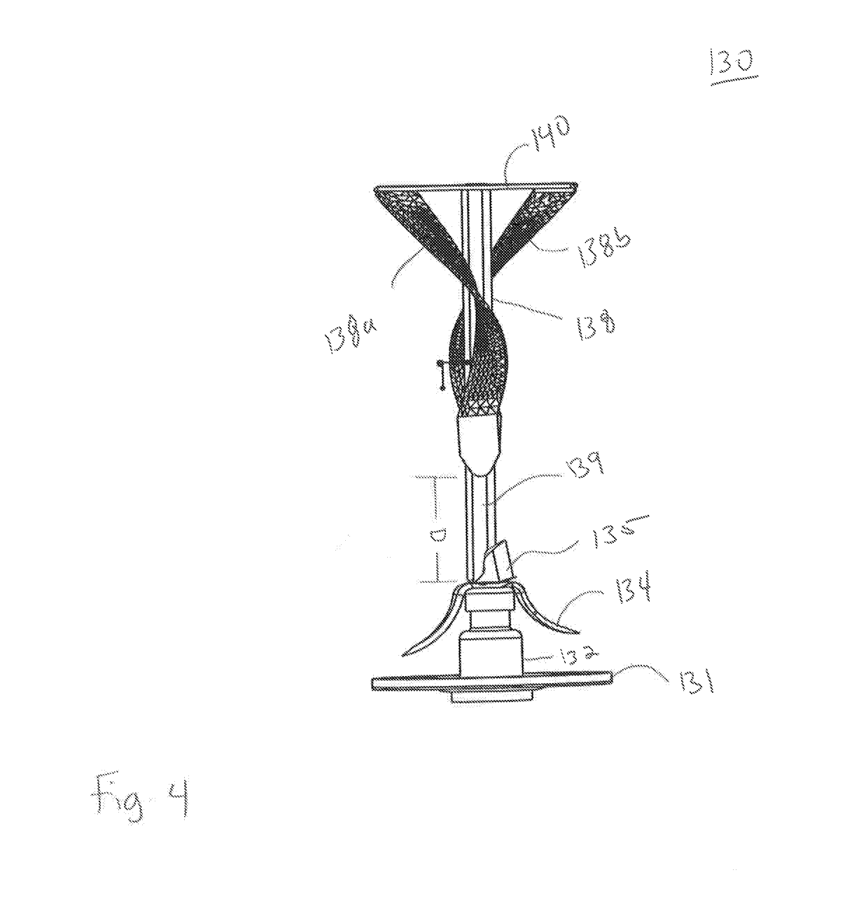

Referring now to FIGS. 3 to 5, the agitator configuration 130 includes a base 131 having a hub 132 containing a bearing assembly (not shown) with a centrally disposed spindle 133 that passes therethrough. The spindle 133 is connected to a splined socket (not shown) disposed at the center of the bottom of the base 131. The splined socket (not shown) receives a complementary splined shaft (not shown) disposed in the recess (not shown) in the base 110. The splined shaft (not shown) in the recess (not shown) transfers rotary power from the electrical motor (not shown) in the base 110 when the blending jar 120 is mounted on the base 110 and the electronic controls 112 are energized.

In the illustrated embodiment, the agitator configuration 130 includes a blade stack mounted on the spindle 133. The blade stack is designed to allow for traditional blending functions while simultaneously providing improved food processing capabilities without the need to remove, change or alter the blade assembly within the blending appliance 100. The blade stack includes a top or first blade form 135 and a second or bottom blade form 134. The blade forms 135, 134 may be made of any durable material such as metal, steel, carbon, composites, or any combinations of such material which can be sharpened and withstand the high stresses and heats generated in this environment.

The top blade form 135 and the bottom blade form 134 are preferably similar to a conventional blender blade design (one or more generally U-shaped blades). In particular, the top blade form 135 includes a central, substantially flat base 135a that extends radially with respect to the rotational axis R-R. of the blade assembly. A first wing portion 135b extends at a first angle upward from the base 135a and a second wing portion 135c extends at a second angle upward from an opposing end of the base 135a. While it is preferred that first and second wing portion's respective 135b, 135c angles are not equal so as to provide enhanced blending and processing, it should be noted that such angles may be identical.

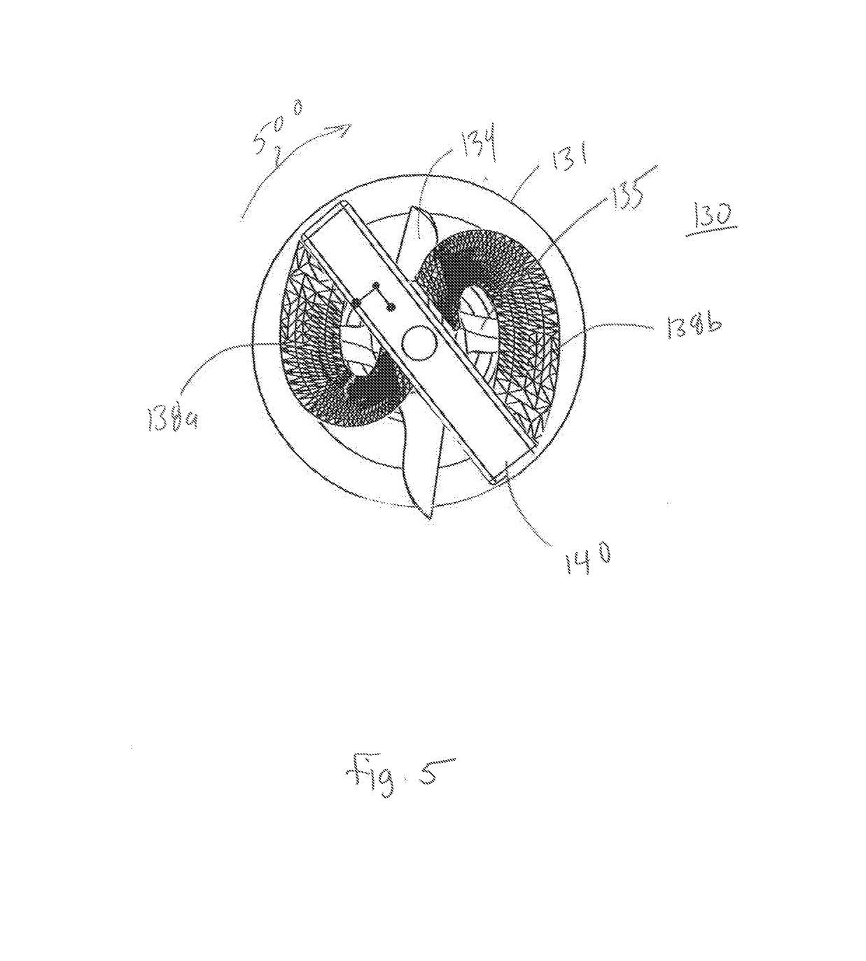

In an embodiment, the leading edges of the first and second wing portions 135b, 135c are sharpened in the direction of rotation of the agitator configuration 130. For example, in the illustrated embodiment in FIG. 3, the leading edges of the first and second wing portions 135b, 135c are sharpened for a clockwise rotation of the agitator configuration 130 about axis A-A represented by arrow 500 in FIG. 5. However, this is not meant to be limiting as the opposite edges of the first and second wing portions 135b, 135c may be sharpened for a counter-clockwise rotation of the agitator configuration 130 about axis A-A opposite to the direction of rotation represented by arrow 500 in FIG. 5.

As with the top blade form 135, the bottom blade form 134 includes a central, substantially flat base 134a extending radially with respect to the rotational axis R-R. of the agitator configuration 130. First 134b and second 134c curved blades are preferably formed integrally with the base 134a, and extend downward and outward from opposing ends of the base 134a. The spiral shape of the blades 134b and 134c enhances blending and processing, and permits the edges of the blades 134b and 134e to extend to adjacent the agitator configuration base 131. In this manner, blended and processed items are dislodged and forced upward from the bottom of the jar 120.

In an embodiment, the leading edges of the first and second wing portions 134b, 134c are sharpened in the direction of rotation of the agitator configuration 130. For example, in the illustrated embodiment in FIG. 3 the leading edges of the first and second wing portions 134b, 134c are sharpened for a clockwise rotation of the agitator configuration 130 about axis A-A represented by arrow 500 in FIG. 5. However, this is riot meant to be limiting as the opposite edges of the first and second wing portions 134b, 134c may be sharpened for a counter-clockwise rotation of the agitator configuration 130 about axis A-A opposite to the direction of rotation represented by arrow 500 in FIG. 5.

In an embodiment, the agitator configuration 130 includes a blade form 138 disposed above the blade stack comprised of the top and bottom blade forms 135, 134 and mounted on a rotary shaft 139. The blade form 138 may be made of any durable material such as metal, steel, carbon, composites, or any combinations of such material which can withstand the high stresses and heats generated in this environment. The rotary shaft 139 is connected at its bottom end to the spindle 133. The blade form 138 includes a pair of opposing first 138b and second 138c elongated spiral blades that spiral upwardly along the shaft 139 towards an upper portion of the interior of the blending jar 110. The first 138b and second 138c spiral blades connect on a first end to a point on the shaft 139 located a distance D above the top and bottom blade forms 135, 134, The first 138h and second 138e spiral blades extend from this point and connect on a second end to a crossbar 140 attached to the distal end of the shaft 139. The crossbar 140 is attached at its midpoint to the shaft 139 and is positioned perpendicularly to the shaft 139. The crossbar 140 has a length L and the opposite ends of the first 138b and second 138c spiral blades connect to the opposing ends of the crossbar 140 at a distance of one-half L from the shaft 139, Thus, the blade form 138 including the first 138b and second 138c spiral blades and the crossbar 140 rotate as the shaft 139 is rotated by the spindle 133.

In the illustrated embodiment, the first 138b and second 138c spiral blades curve clockwise from their first ends connected to the shaft 139 to their second ends attached to the opposing ends of the crossbar 140 for a clockwise rotation of the agitator configuration 130. In another embodiment, the first 138b and second 138c spiral blades spiral counter-clockwise from their first ends connected to the shaft 139 to their second ends attached to the opposing ends of the crossbar 140 for a counter-clockwise rotation of the agitator configuration 130.

It should be noted that the blade form 138 comprised of the first 138b and second 138c spiral blades may be added to any existing or Nature agitator blade configuration. The first 138b and second 138c spiral blades are formed from suitable material formed into a fiat bar shape and spiral in the direction of rotation in a range from greater than zero degrees 0° to less than ninety-degrees 90. The blade form 138 including first 138b and second 138c spiral blades prevent cavitation of solid or frozen ingredients that will solidify during blending and create a cavity or air pocket around the agitator blade configuration 130 in the upper portion of the blending jar 120. The first 138b and second 138c spiral blades create turbulence preventing solidification of the solid or frozen ingredients and a suction that forces the ingredients into the top and bottom blade forms 135, 134 below. The distance D and length L are dependent upon the diameter and height of the blending jar 120 and optimized to stir blended contents and force ingredients down into the blade forms 135 and 134 from the upper portion of the blending jar 120, particularly at low blending speeds required for blending protein drinks and the like.

It will be appreciated by persons skilled in the art that the present invention is not limited to what has been particularly shown and described herein above. In addition, unless mention was made above to the contrary, it Should be noted that all of the accompanying drawings are not to scale. A variety of modifications and variations are possible in light of the above teachings without departing from the scope and spirit of the invention, which is limited only by the following claims.

What is claimed is:

1. A blending appliance, comprising:
a motorized base;
a blending container, and
an agitator configuration fitted into an opening of the blending container and rotatably coupled to the motorized base when the blending container is mounted on the motorized base, the agitator configuration including:
a blade arrangement disposed on a spindle performing blending operations on ingredients at a lower end of the blending container; and
a blade form disposed on a shaft connected to the spindle performing additional blending operations on ingredients in an upper portion of the blending container, the blade form including at least two spiral blades disposed on the shaft, and each of the spiral blades having a first end connected to the shaft at a pre-determined distance from the blade arrangement and a second end connected to opposing ends of a crossbar attached at its midpoint to a distal end of the shaft.

2. The blending appliance of claim 1, wherein the blade arrangement includes a top blade form including opposing wing portions angled upward.

3. The blending appliance of claim 1, wherein the blade arrangement includes a bottom blade form including opposing wing portions angled downward.

4. The blending appliance of claim 1, wherein the spiral blades are formed from flat strips.

5. An agitator configuration, comprising:
a blade arrangement disposed on a spindle performing blending operations on ingredients at a lower end of a blending container; and
a blade form disposed on a shaft connected to the spindle performing additional blending operations on ingredients in an upper portion of the blending container, the blade form including at least two spiral blades disposed on the shaft, and each of the spiral blades having a first end connected to the shaft at a pre-determined distance from the blade arrangement and a second end connected to opposing ends of a crossbar attached at its midpoint to a distal end of the shaft.

6. The agitator configuration of claim 5, wherein the blade arrangement includes a top blade form including opposing wing portions angled upward.

7. The agitator configuration of claim 5, wherein the blade arrangement includes a bottom blade form including opposing wing portions angled downward.

8. The agitator configuration of claim 5, wherein the spiral blades are formed from flat strips.
